(19) United States
(12) Patent Application Publication
(10) Pub. No.: US 2015/0039400 A1
(43) Pub. Date: Feb. 5, 2015

(54) BUSINESS VIABILITY EVALUATION APPARATUS, BUSINESS VIABILITY EVALUATION METHOD, AND BUSINESS VIABILITY EVALUATION PROGRAM

(71) Applicant: Hitachi, Ltd., Tokyo (JP)

(72) Inventor: Youichi HORII, Tokyo (JP)

(73) Assignee: Hitachi, Ltd.

(21) Appl. No.: 14/445,092

(22) Filed: Jul. 29, 2014

(30) Foreign Application Priority Data
Jul. 31, 2013 (JP) 2013-159503

(51) Int. Cl. G06Q 10/06; G06N 7/00

(52) U.S. Cl. CPC G06Q 10/0639; G06N 7/005
USPC 705/7.38

(57) ABSTRACT

A business viability evaluation apparatus includes: a data management part that receives that a user enters a calculation process which is a process of calculating a value of an evaluation item for evaluating a business and a prerequisite which is an input value to the calculation process; and a business viability evaluation part that creates a value of the evaluation item in time series based on the calculation process and the prerequisite, displays the value of the evaluation item created in time series, receives that the user re-enters a changed prerequisite, re-creates a value of the evaluation item in time series based on the calculation process and the changed prerequisite, and displays the value of the evaluation item re-created in time series.

### CROSS REFERENCE TO RELATED APPLICATIONS

This application claims the benefit of Japanese Patent Application No. 2013-159503 filed on Jul. 31, 2013, the disclosure of which is incorporated herein by reference.

### BACKGROUND OF THE INVENTION

1. Field of the Invention

The present invention relates to a business viability evaluation apparatus, a business viability evaluation method, and a business viability evaluation program.

2. Description of the Related Art

When a business enterprise carries out a business, the enterprise estimates profitability of the business and evaluates the estimated profitability in advance. One of commonly-used evaluation methods is to set a plurality of prerequisites such as a revenue, an expenditure, a depreciation cost, an interest cost, and a tax, and to calculate a management indicator, such as, for example, an amount of cumulative profits, for each of the prerequisites. A typical example of such a business is a “project”. In the project, investment is performed in an initial period. Cost of the investment is recovered by profits gained during a plurality of periods that follows.

Nakazawa, M. and Ikeda, K. (1998), Introduction to cash flow management, Tokyo, Nihon Keizai Shimbun Inc., pp. 75-88 (which is hereinafter referred to as Non-Patent Document 1) discloses an example in which, in a project as described above, a net present value, an internal rate of return, a payout time, and the like are calculated based on an investment amount in an early stage and a cash flow obtained in a later stage. Japanese Laid-Open Patent Application, Publication No. 2004-038804 (see, for example, claim 1, FIG. 6, FIG. 9, and FIG. 10) (which is hereinafter referred to as Patent Document 1) discloses a device for predicting cash flow which calculates predicted values of a tax rate, a borrowing rate of interest, a rent change rate, and the like in the past, based on result values of the tax rate, the borrowing rate of interest, the rent change rate, and the like in the past, respectively. One of the predicted values of the tax rate, the borrowing rate of interest, the rent change rate, and the like is randomly acquired. The acquired predicted value is inputted into a calculation formula of a scenario formation element selected by a user, to thereby calculate a predicted cash flow for each period in the future. At this time, the device for predicting cash flow outputs the predicted cash flow in form of a probability distribution.

### SUMMARY OF THE INVENTION

The business enterprise verifies, for example, how a future expenditure changes in time series and how wide is a swing of the expenditure in a given period, while varying a prerequisite. A revenue and expenditure structure is typically hierarchical in which, for example, the expenditure includes an expenditure A, an expenditure B, and an expenditure C; and the expenditure A includes an expenditure Aa and an expenditure Ab. It is highly difficult to detect a prerequisite to be changed, from such a structure. Further, even if the prerequisite to be changed is currently detected, there is a possibility that a value with inappropriate definition is entered by mistake or that data is incorrectly entered and overlooked and an erroneously-obtained result is believed to be reliable.

In Patent Document 1, the device for predicting cash flow fails to deal with the possibility of the inconvenience as described above. The device for predicting cash flow also fails to meet practical needs that a user wants to successively perform entry and output operations while the user can easily see entry and output values necessary for the operations.

The present invention has been made in an attempt to provide a business viability evaluation apparatus in which a determination of a revenue and expenditure structure and an input of a prerequisite is clearly separated from each other, and thus, a change of a management indicator is visible when the prerequisite is changed in an interactive manner.

A business viability evaluation apparatus includes: a data management part that receives that a user enters a calculation process which is a process of calculating a value of an evaluation item for evaluating a business and a prerequisite which is an input value to the calculation process; and a business viability evaluation part that creates a value of the evaluation item in time series based on the calculation process and the prerequisite, displays the value of the evaluation item created in time series, receives that the user re-enters a changed prerequisite, re-creates a value of the evaluation item in time series based on the calculation process and the changed prerequisite, and displays the value of the evaluation item re-created in time series.

Other means will be described hereinafter in an embodiment for carrying out the present invention.

The present invention makes it possible to clearly separate a determination of a revenue and expenditure structure and an input of a prerequisite from each other and to make visible a change of a management indicator when the prerequisite is changed in an interactive manner.

### BRIEF DESCRIPTION OF THE DRAWINGS

FIG. 1 is a diagram illustrating a configuration of a business viability evaluation apparatus according to an embodiment of the present invention.

FIG. 2 is a diagram illustrating an example of a revenue and expenditure structure description file according to the embodiment.

FIG. 3 is a diagram illustrating a continuation of the example of the revenue and expenditure structure description file of FIG. 2 according to the embodiment.

FIG. 4A, FIG. 4B, and FIG. 4C are diagrams each for explaining a probability distribution chart according to the embodiment.

FIGS. 5A to 5E are diagrams each for explaining a computing method using a probability distribution according to the embodiment.

FIG. 6 is a diagram illustrating an example of a revenue and expenditure structure screen which is one of a collectively-called business viability evaluation screen according to the embodiment.

FIG. 7 is a diagram illustrating another example of a revenue and expenditure structure screen of the business viability evaluation screen according to the embodiment.

FIG. 8 is a diagram illustrating an example of a related chart screen of the business viability evaluation screen according to the embodiment.

FIG. 9 is a diagram illustrating an example of a revenue and expenditure changes screen of the business viability evaluation screen according to the embodiment.

FIG. 10 is a diagram illustrating an example of a probability distribution screen according to the embodiment.

FIG. 11 is a diagram illustrating an example of a management indicator screen of the business viability evaluation screen according to the embodiment.

FIG. 12 is a diagram illustrating an example of a scenario screen of the business viability evaluation screen according to the embodiment.

FIG. 13 is a flowchart illustrating steps of an entire processing according to the embodiment.

FIG. 14A, FIG. 14B, and FIG. 14C are diagrams each for explaining a re-entry of a prerequisite according to the embodiment.

FIG. 15A, FIG. 15B, and FIG. 15C are diagrams each for explaining a method of displaying a probability distribution according to the embodiment.

### DETAILED DESCRIPTION OF THE EXEMPLARY EMBODIMENT

Next is described an embodiment for carrying out the present invention (to be simply referred to as “this embodiment” hereinafter, with reference to related drawings.

### <Business Viability Evaluation Apparatus>

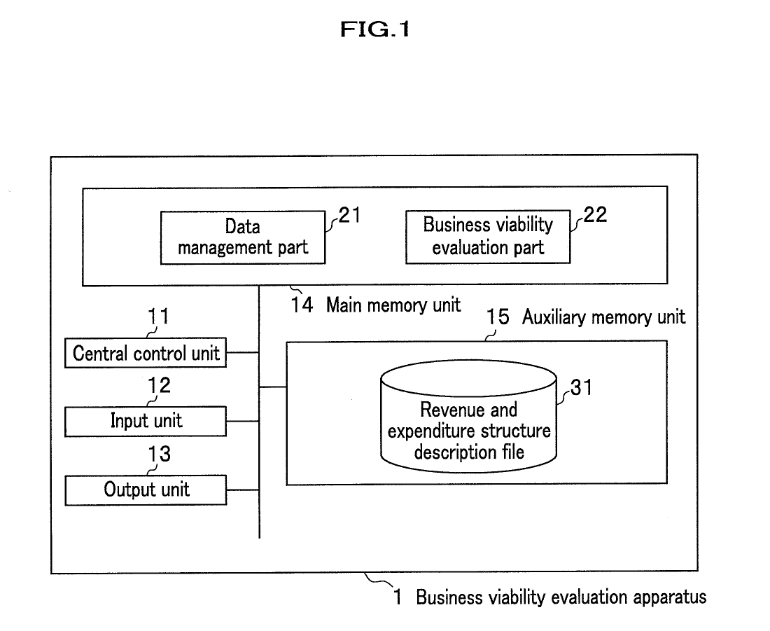

With reference to FIG. 1, a configuration of a business viability evaluation apparatus 1 is described. The business viability evaluation apparatus 1 is embodied by a generally-available computer. The business viability evaluation apparatus 1 includes a central control unit 11, an input unit 12 such as a keyboard and a mouse, an output unit 13 such as a display, a main memory unit 14, and an auxiliary memory unit 15, which are connected to each other via a bus. A data management part 21 and a business viability evaluation part 22 in the main memory unit 14 are each a program. For simplification of explanation, the components 21 and 22 are herein assumed to directly perform their respective functions (which will be described in detail hereinafter). It is, however, the central control unit 11 that actually reads and loads the programs from the auxiliary memory unit 15 into the main memory unit 14 and thereby performs the functions of the programs. The auxiliary memory unit 15 stores therein a revenue and expenditure structure description file 31.

### <Revenue and Expenditure Structure Description File>

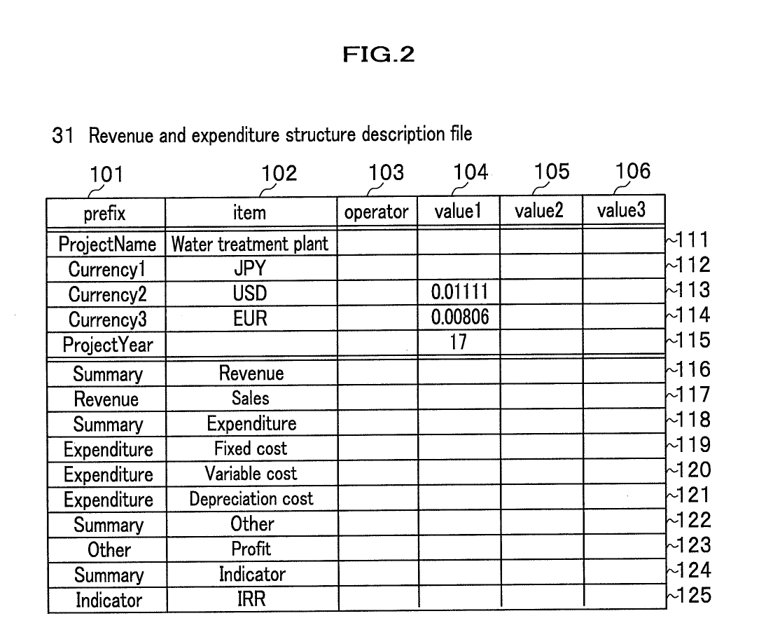

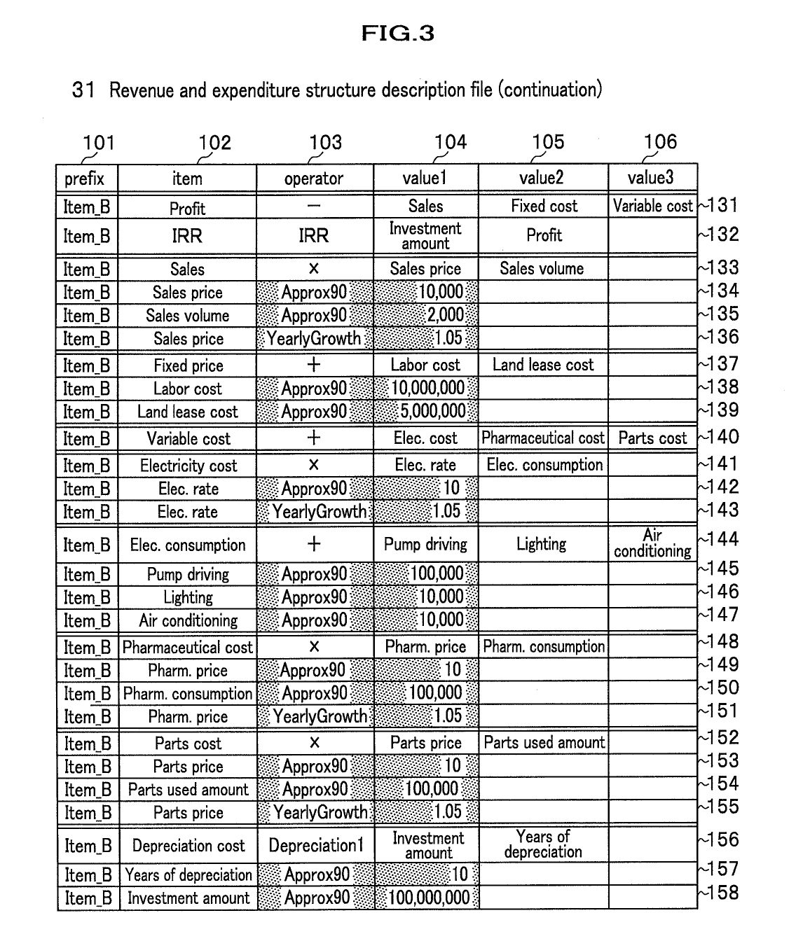

With reference to FIG. 2 and FIG. 3, the revenue and expenditure structure description file 31 is described. FIG. 3 is a continuation of FIG. 2. Though illustrated spanning the two figures, the revenue and expenditure structure description file 31 is one table with a plurality of rows and a plurality of columns (fields). The revenue and expenditure structure description file 31 stores therein, in association with a category stored in a prefix field 101: a name of an item in an item field 102; a name of an operator an operator field 103; a value 1 in a value1 field 104; a value 2 in a value2 field 105; and a value 3 in a value3 field 106. The revenue and expenditure structure description file 31 may further contain a value4 field for storing therein a value 4 and thereafter and may also contain a field for storing each unit of the value 1, value 2, and the like.

The prefix field 101 is any one of “ProjectName”, “Currency1”, “Currency2”, “Currency3”, “ProjectYear”, “Summary”, “Revenue”, “Expenditure”, “Other”, “Indicator”, and “Item_B”.

“ProjectName” refers to a name of a project.

“Currency1” refers to a first currency of a plurality of currencies each indicating an amount by which profitability of the project is evaluated. Similarly, “Currency2” refers to a second currency, and “Currency3”, a third currency.

“ProjectYear” refers to a time period of the project. The time period herein indicates a time length of the project, and a unit thereof is herein a “year”.

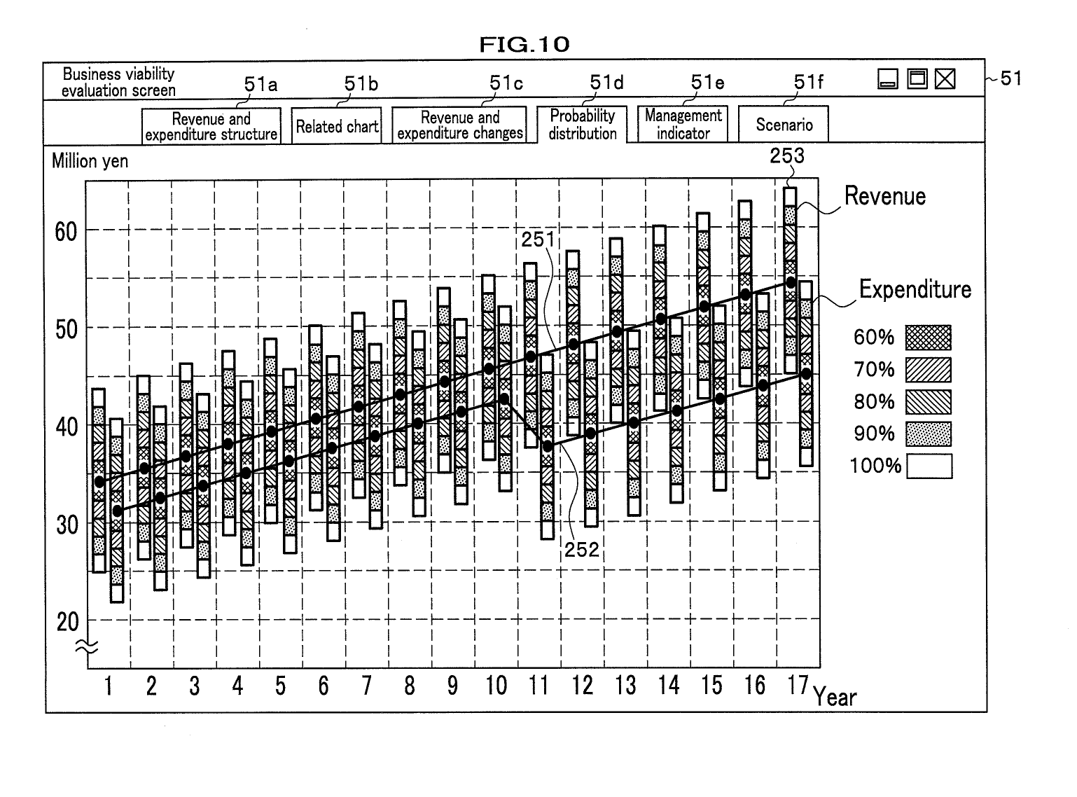

“Summary” refers to a name of a main item. A value of the main item is displayed as a time series indicator (see, for example, FIG. 10).

“Revenue” refers to a revenue which is one of the main items.

“Expenditure” refers to an expenditure which is also one of the main items.

“Other” refers to a main item other than “Revenue” and “Expenditure”.

“Indicator” refers to a management indicator. In this embodiment, one indicator defined throughout the project period is specifically referred to as a “management indicator”.

“Item_B” refers to a definition. The definition includes: a definition for defining a calculation formula for calculating a value of an item (a calculation process); a definition for identifying a value itself of an item; a definition for identifying a probability distribution of a value of an item, using a parameter; and a definition for defining an year-on-year percentage change of a value of an item (to be hereinafter described in detail).

Different categories in the prefix field 101 store respective different data in the item field 102 through the value3 field 106 of the revenue and expenditure structure description file 31.

If the category is “ProjectName”, a name of a project is stored in the item field 102 as it is, and the other fields are left blank (a row 111).

If the category is “Currency1”, characters indicating the first currency is stored in the item field 102 and the other fields are left blank (a row 112).

If the category is “Currency2” or “Currency3”, characters indicating the second or third currency is stored in the item field 102; a conversion rate (an exchange rate) which is multiplied by an amount of the first currency is stored in the value1 field 104; and the other fields are left blank (rows 113 and 114). Note that the revenue and expenditure structure description file 31 may contain rows of “Currency4”, “Currency5”, and the like.

If the category is “ProjectYear”, a time period of the project is stored in the value1 field 104, and the other fields are left blank (a row 115).

If the category is “Summary”, any one of “Revenue”, “Expenditure”, “Other”, and “Indicator” is stored in the item field 102, and the other fields are left blank (rows 116, 118, 122, and 124).

If the category is “Revenue”, a detailed item of the revenue is stored in the item field 102, and the other fields are left blank (a row 117). A number of various detailed items of the revenue may be possible such as “Sales”, “Service fee”, and “Subsidy”. For simplification of explanation, however, only “Sales” is stored as the detailed item of the revenue in this embodiment.

If the category is “Expenditure”, a detailed item of the expenditure is stored in the item field 102, and the other fields are left blank (rows 119 to 121). In this embodiment, the detailed item of the expenditure includes “Fixed cost”, “Variable cost”, and “Depreciation cost”.

If the category is “Other”, a detailed item of an other main item is stored in the item field 102, and the other fields are left blank (a row 123). A number of various detailed items of the other main item may be possible such as “Profit”, “Debt payment”, and “Profit distribution”. For simplification of explanation, however, only “Profit” is stored as the detailed item of the revenue in this embodiment.

If the category is “Indicator”, a management indicator is stored in the item field 102, and the other fields are left blank (a row 125). A number of various detailed items of the management indicator may be possible such as “IRR (Internal Rate of Return)”, “Net present value”, and “Payout time”. For simplification of explanation, however, only “IRR” is stored as the detailed item of the management indicator in this embodiment.

If the category is “Item_B”, there are types 1 to 6, which are described separately below.

Type 1 is a calculation formula of four arithmetic operations.

Rows 131, 133, 137, 140, 141, 144, 148, and 152 of FIG. 3 each define a calculation formula concerning four arithmetic operations as follows.

The row 131 defines a calculation formula of “Profit=Sales−Fixed cost−Variable cost”.

The row 133 defines a calculation formula of “Sales=Sales price×Sales volume”.

The row 137 defines a calculation formula of “Fixed cost=Labor cost+Land lease cost”.

The row 140 defines a calculation formula of “Variable cost=Electricity cost+Pharmaceutical cost+Parts cost”.

The row 141 defines a calculation formula of “Electricity cost=Electric rate (unit price)×Electrical consumption”.

The row 144 defines a calculation formula of “Electrical consumption=Pump driving+Lighting+Air conditioning”. “Pump driving” used herein means an electrical consumption for the pump driving. The same applies to “Lighting” and “Air conditioning”.

The row 148 defines a calculation formula of “Pharmaceutical cost=Pharmaceutical price×Pharmaceutical consumption”.

The row 152 defines a calculation formula of “Parts cost=Parts price×Parts used amount”.

Type 2 is a calculation formula other than the four arithmetic operations.

Rows 132 and 156 each define a calculation formula concerning a calculation other than the four arithmetic operations.

The row 132 defines a calculation of an IRR using a prescribed method based on an investment amount and a profit (before depreciation). Assume a case in which a time period of a project is “m years” and Formula 1 showing relationship of cash flows in each period is given as below. The IRR can be calculated by solving an equation with “r” in Formula 1 as an unknown. Herein, r (0<r) is a discount rate.

C₀+C₁/(1+r)+C₂/(1+r²+ . . . +Cₘ/(1+r)^{m}=0 [Formula 1]

Cₙ is a cash flow in a n-th period(n=0, 1, 2, . . . , m). The cash flow is a profit before depreciation (Sales−Fixed cost−Variable cost). C₀ is equal to an investment amount in an initial stage. The investment amount is an amount going out from an enterprise as cash. Hence, C₀ always takes a negative value. Cₙ (n=1, 2, . . . , m) takes a positive or a negative value. Typically, Cₙ takes a negative value when n is relatively small (for example, in an early stage after investment), and, a positive value when n is sufficiently large (for example, when a facility or the like is in a stable operation).

Even if a monetary value in a 0-th period (at a current point of time) when investment is made is nominally equal to a monetary value in an n-th period (n≠0), the two monetary values are not necessarily evaluated on equal terms. In evaluating Cₙ, the cash flow in the n-th period (n≠0), based on the current monetary value, it is necessary to divide Cₙ by (1+r)ⁿ. A left member of Formula 1 thus corresponds to a current monetary value of cash flows generated throughout all periods of the project, which is suitable for being used as an evaluated value of the project at a current point of time. The evaluated value is called a “net present value”. The IRR is a discount rate which makes Formula 1 satisfied, that is, which makes a net present value “0”. The larger the IRR, the larger the value as an investment.

The row 156 defines how a depreciation cost is calculated based on an investment amount and years of depreciation using a prescribed method. As is known in the art, a depreciation cost in each period is calculated by first subtracting a prescribed remaining book value from the investment amount, to thereby obtain the subtracted result as a depreciation amount required, and then dividing the depreciation amount required, by the years of depreciation (a straight-line method). Or, the depreciation cost at each period can be calculated by multiplying the depreciation amount required or a book value at an end of a previous period by a prescribed depreciation ratio for each period (a declining-balance method). The remaining book value may take a value of “0”. “Depreciation1” shows that the depreciation cost in each period is calculated using the straight-line method. “Depreciation2” shows that the depreciation cost in each period is calculated using the declining-balance method.

Type 3 is a method of defining a value as a prerequisite.

Though not illustrated in FIG. 3, if, for example, the item field 102 of a given row contains “Sales price”; the operator field 103, “=”; and the value1 field 104, “100”, the row shows that the “Sales price” takes a fixed price with a value of “100”. Note that if a value stored in the value1 field 104 is an amount of money, a first currency is used as a unit thereof (the same applies to Types 4 and 5 hereinafter).

Type 4 is a method of defining a value as a prerequisite using a continuous probability distribution.

If an input value cannot be determined as a specific value, a probability distribution of the input value is generally used instead. It is commonly performed that, for example, assuming that the input value shows a normal distribution and a specific form of a distribution thereof is specified by using two parameters, a “mean value” and a “dispersion”. Though not illustrated in FIG. 3, “Sales price” may be put in the item field 102 of a row; “Dispersion 10”, in the operator field 103; and “100”, in the value1 field. In this case, the row shows a continuous-type probability distribution in which “Sales price” is specified by the two parameters, the mean value of “100” and the dispersion of “10”.

Type 5 is a method of defining a value as a prerequisite using a discrete probability distribution.

In this embodiment, the continuous probability distribution of Type 4 is made simpler, and a distribution of an input value as a prerequisite is discretely specified using two parameters, a “mean value” and an “accuracy”. The row 134, for example, shows that the sales price has a probability distribution of discrete type specified by two parameters, the mean value of “10,000” and the accuracy of “90%”.

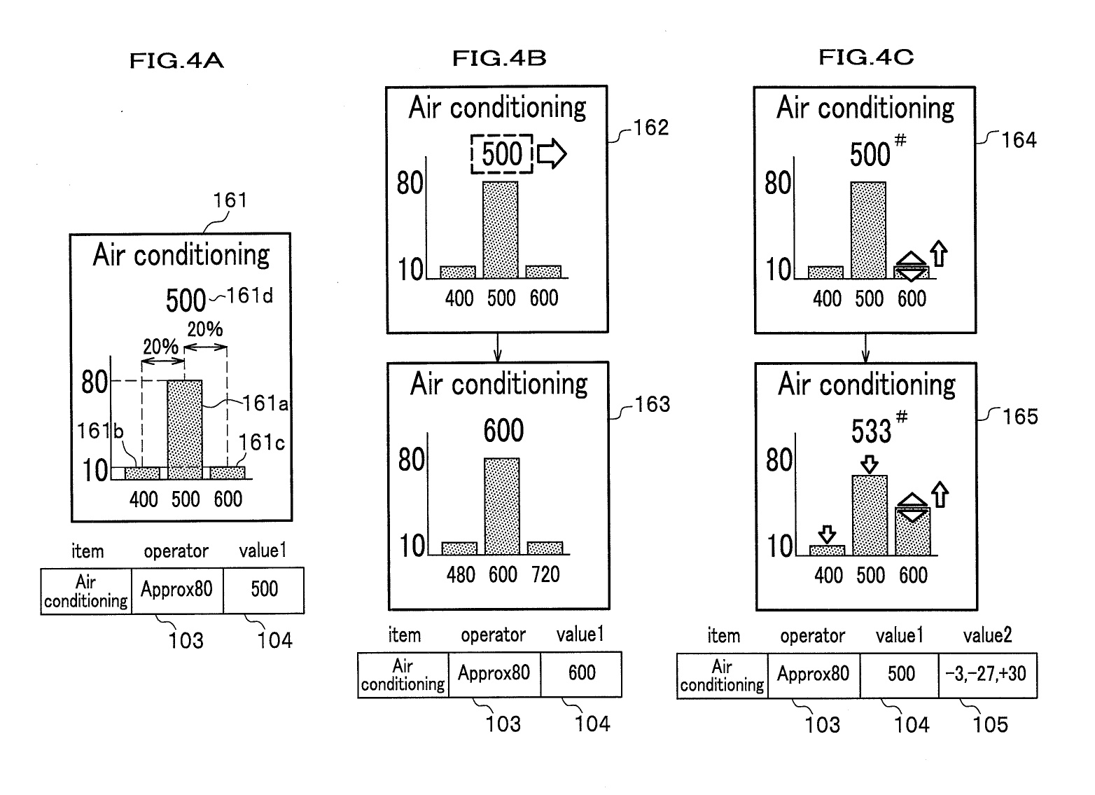

Referring to FIG. 4A, next is described what kind of probability distribution an electrical consumption presents, in a case where an electrical consumption of “Air conditioning” takes the mean value of “500” and the accuracy of “80%”. A distribution chart 161 is made up of three bars drawn on a plane of coordinates with the electrical consumption on a horizontal axis and an event probability on a vertical axis. A bar 161a in the middle of the three bars indicates “500” on the horizontal axis. “500” corresponds to “500” stored in the value1 field 104 of the revenue and expenditure structure description file 31. The middle bar 161a indicates “80” on the vertical axis. “80” corresponds to “Approx80” stored in the operator field 103 of the revenue and expenditure structure description file 31.

A bar 161b in the leftward of the three bars indicates “400” on the horizontal axis. “400” is a value obtained by subtracting, from a value of “500” which is indicated on the horizontal axis of the middle bar 161a, a value of “100” which is “20%” of “500” described above. “20%” is a value obtained by subtracting “80%” of “Approx80” stored in the operator field 103 of the revenue and expenditure structure description file 31 from “100%”. The leftward bar 161b indicates “10” on the vertical axis. “10” is half a value obtained by subtracting “80%” of “Approx80” stored in the operator field 103 of the revenue and expenditure structure description file 31 from “100%”.

A bar 161c in the rightward of the three bars indicates “600” on the horizontal axis. “600” is a value obtained by subtracting, from the value of “500” which is indicated on the horizontal axis of the middle bar 161a, the value of “100” which is “20%” of “500” described above. “20%” is a value obtained by subtracting “80%” of “Approx80” stored in the operator field 103 of the revenue and expenditure structure description file 31 from “100%”. The rightward bar 161c indicates “10” on the vertical axis. “10” is half a value obtained by subtracting “80%” of “Approx80” stored in the operator field 103 of the revenue and expenditure structure description file 31 from “100%”.

“500” (designated at reference numeral 161d) is shown just below a character string of “Air conditioning”. This indicates a position of the middle bar 161a on the horizontal axis or an expected value of any of the middle bar 161a, the leftward bar 161b, and the rightward bar 161c. In order to distinguish “500” as the value indicating the position of the middle bar 161a on the horizontal axis from “500” as the expected value, for example, a prescribed sign such as “#” may be added to the latter “500” as the expected value, and in the meantime, no sign may be added to the former “500” as the value indicating the position of the middle bar 161a on the horizontal axis. “500” (at reference numeral 161d) illustrated in FIG. 4A is a value indicating the position of the middle bar 161a on the horizontal axis. In a case where “500” is an expected value, however, the value is still the same as that indicating the position, both of which can be obtained by calculating 500=500×80%+400×10%+600×10%. The expected value may be displayed as, for example, “500#”. Though FIG. 4B and FIG. 4C will be described in detail hereinafter, in FIG. 4C, an expected value is displayed just below the character string of “Air conditioning”.

The same explanation of “Air conditioning” as described above applies to the rows 135, 138, 139, 142, 145 to 147, 149, 150, 153, 154, 157, and 158 of FIG. 3.

Type 6 is a method of defining a rate of change of a value of the item.

A row 136 of FIG. 3 shows that a value of the sales price in a given period is a product obtained by multiplying a value of the sales price in a previous period thereof by the rate of change of “1.05”. The same explanation applies to the rows 143, 151, and 155 of FIG. 3.

Though not illustrated in FIG. 3, a given row may contain, for example, “Sales price” in the item field 102; “YearlyRate” in the operator field 103; “1.00” in the value1 field 104; “1.10” in the Value2 field 105; “1.05” in the value3 field 106; and the like (hereinafter the same down to a valueN field, though not shown in the figure). The given row thus shows that, on a basis of the “sales price” in a first period as a reference, the sales price in a second period is “1.10” times the reference, and the sales price in the third period is “1.05” times the reference (hereinafter the same down to the N-th period).

The rows of Types 1 and 2 of the revenue and expenditure structure description file 31 of FIG. 2 and its continuation, FIG. 3, are deemed to be used for defining a revenue and expenditure structure. On the other hand, the rows of Types 3 to 6 of the revenue and expenditure structure description file 31 of FIG. 3 are deemed to be used for storing an input value as a prerequisite.

Though details will be described later, a user firstly enters appropriate data in a part for defining a revenue and expenditure structure, and secondly enters appropriate data in a part for storing an input value as a prerequisite. Typically, the user firstly enters the data to the fields of FIG. 2 and FIG. 3. in tabular forms. Then, when the user wants to change and re-enter the prerequisite, the user may directly enter appropriate data to a shaded portion of the table. Or, the user may enter the appropriate data by manipulating the distribution chart 161 (FIG. 4A) displayed on a screen using a mouse, a finger, or the like, which is easier than the direct entry.

Above is described an example in which a revenue and expenditure structure of a calculation formula or the like and (a probability distribution of) a value of the sales price or the like are the same through all periods of the project. Normally, the revenue and expenditure structure should be fixed through all of the periods. However, (the probability distribution of) the value of the sales price or the like may be defined for each of the periods. For example, such rows as “Item_B, Sales price (up to a tenth period), Approx90, 10,000” and “Item_B, Sales price (in and after an eleventh period), Approx80, 12,000” of the revenue and expenditure structure description file 31 may be defined at the same time.

### <Four Arithmetic Operations of a Plurality of Values Represented by Probability Distributions>

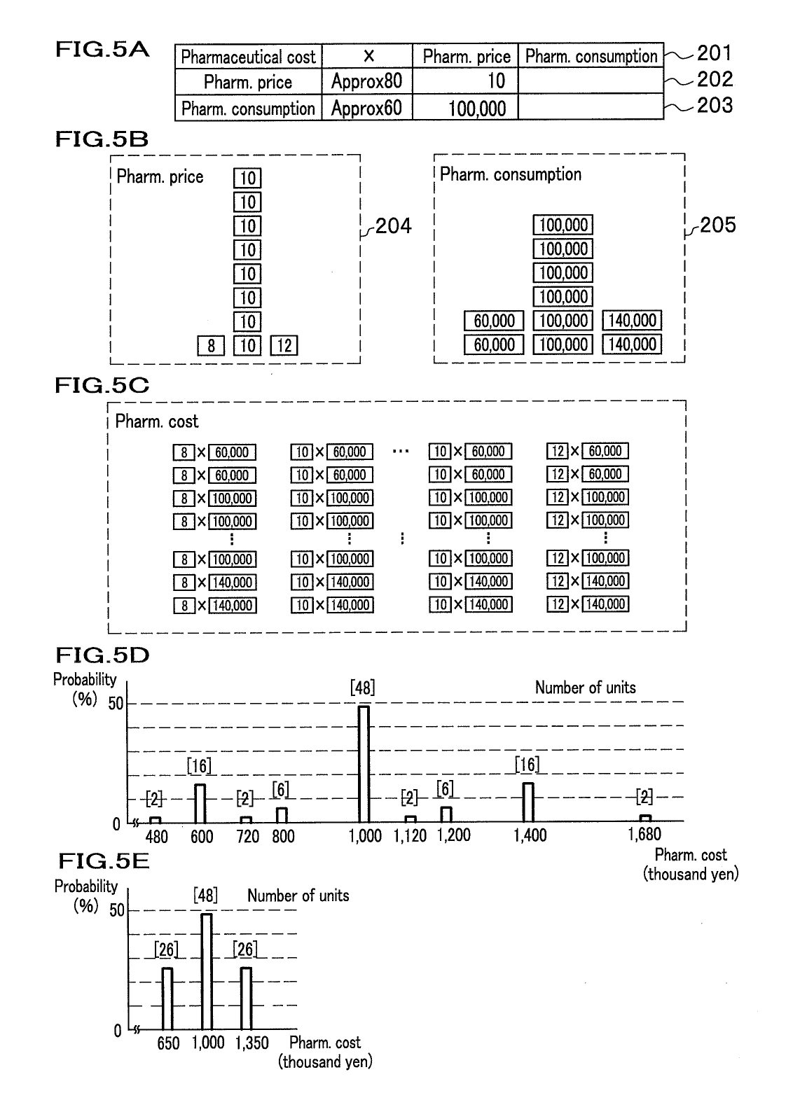

Referring to FIGS. 5A to 5E, a specific example of four arithmetic operations of a plurality of values represented by respective probability distributions is described. Of the rows of the revenue and expenditure structure description file 31, let a row defining a calculation formula for calculating “Pharmaceutical cost” be a row 201 of FIG. 5A. Similarly, let a row representing a probability distribution of a value of “Pharmaceutical price” be a row 202 of FIG. 5A, and, a probability distribution of a value of “Pharmaceutical Consumption”, a row of 203 of FIG. 5A.

A diagrammatic illustration of the row 202 is a pharmaceutical price 204 of FIG. 5B. A probability of a pharmaceutical price of “10” is the highest, which is “80%”. Its diagrammatic illustration is a middle column made up of eight rectangles of the pharmaceutical price 204. Meanwhile, a probability of the pharmaceutical price of “8” is “10%”. Its diagrammatic illustration is a leftward column made up of one rectangle in the pharmaceutical price 204. A probability of the pharmaceutical price of “12” is also “10%”. Its diagrammatic illustration is a rightward column made up of one rectangle of the pharmaceutical price 204.

A diagrammatic illustration of the row 203 is a pharmaceutical consumption 205 of FIG. 5B. For example, a probability of a pharmaceutical consumption of “100,000” is the highest, which is “60%”. Its diagrammatic illustration is a middle column made up of six rectangles of the pharmaceutical consumption 205. Meanwhile, a probability of the pharmaceutical consumption of “60,000” is “20%”. Its diagrammatic illustration is a leftward column made up of two rectangles of the pharmaceutical consumption 205. A probability of the pharmaceutical consumption of “140,000” is also “20%”. Its diagrammatic illustration is a rightward column made up of two rectangles of the pharmaceutical consumption 205. There is no special meaning that the number of the rectangles of each of the pharmaceutical price 204 and the pharmaceutical consumption 205 is ten. For simplification of explanation, the number of ten is used as a number small and simple to understand.

The business viability evaluation part 22 of the business viability evaluation apparatus 1 computes a pharmaceutical cost by multiplying a probability distribution of the pharmaceutical price 204 by a probability distribution of the pharmaceutical consumption 205. The obtained pharmaceutical cost is also represented in a form of a probability distribution. More specifically, the business viability evaluation part 22 repeats a processing of multiplying a value in one rectangle of the pharmaceutical price 204 by a value in one rectangle of the pharmaceutical consumption 205, with respect to all of the rectangles in the pharmaceutical consumption 205 (inner loop). Then, the business viability evaluation part 22 repeats a processing of the inner loop with respect to all of the rectangles in the pharmaceutical price 204 (outer loop). After completion of the processing of the outer loop, the business viability evaluation part 22 holds 10×10=100 units of the calculation results as shown in FIG. 5C.

The business viability evaluation part 22 prepares a probability distribution based on the calculation results as shown in FIG. 5D. For example, the number of the calculation results of “10 yen×100,000 grams=1,000,000 yen” is 48, which is the largest. The total number of the calculation results is 100, and the number of 48 thus corresponds to a probability of 48%. The other calculation results are distributed in four positions for each of a right side and a left side of the calculation results of “1,000,000”. The distribution extends across 9 positions in total because the pharmaceutical price takes a value of three types (8, 10, and 12), the pharmaceutical consumption takes a value of only three types (60,000, 100,000, and 140,000), and the number of possible combinations is thus 3×3=9 types. Note that description above is made assuming a case in which the four arithmetic operations is a multiplication. In a case of an addition, a subtraction, or a division, each computation is performed in a similar order.

As illustrated in FIG. 5E, the business viability evaluation part 22 can further simplify a probability distribution of the calculation results. In FIG. 5E, “650” corresponding to a position of a leftward bar on the horizontal axis is obtained from a calculation result of “(480×2+600×16+720×2+800×6)/(2+16+2+6)” of FIG. 5D. “26%” corresponding to a position of the leftward bar of FIG. 5E on the vertical axis is obtained from a calculation result of “2+16+2+6”. “1,350” corresponding to a position of a rightward bar of FIG. 5E on the horizontal axis is obtained from a calculation result of “(1,120×2+1,200×6+1,400×16+1,680×2)/(2+6+16+2)” of FIG. 5D. “26%” corresponding to a position of the rightward bar of FIG. 5E on the vertical axis is obtained from a calculation result of “2+6+16+2”. As described above, a probability distribution as a calculation result and another probability distribution as another calculation result are subjected to a computation, to thereby obtain a computed probability distribution having a value of a hierarchically upper-level item. This can improve a throughput speed.

For example, the business viability evaluation part 22 computes a variable cost by adding up an electricity cost, a pharmaceutical cost, and a parts cost (the row 140 of FIG. 3). Inversely calculated, the electricity cost is calculated by multiplying an electric rate (a unit price) by an electrical consumption (the row 141). The electrical consumption is calculated by adding up those of pump driving, lighting, and air conditioning (the row 144). The lowest-level electrical consumptions of pump driving, lighting, and air conditioning are entered directly by a user in form of probability distributions. Meanwhile, the electricity cost, the variable cost, and the like are calculation results each obtained by subjecting one probability distribution and another to a calculation and are also represented in form of probability distributions. In other words, the calculation results between one probability distribution and another are accumulated at multiple levels. This has a large effect in simplifying, for example, the calculation results of FIG. 5D into those of FIG. 5E, each time the business viability evaluation part 22 performs such a calculation.

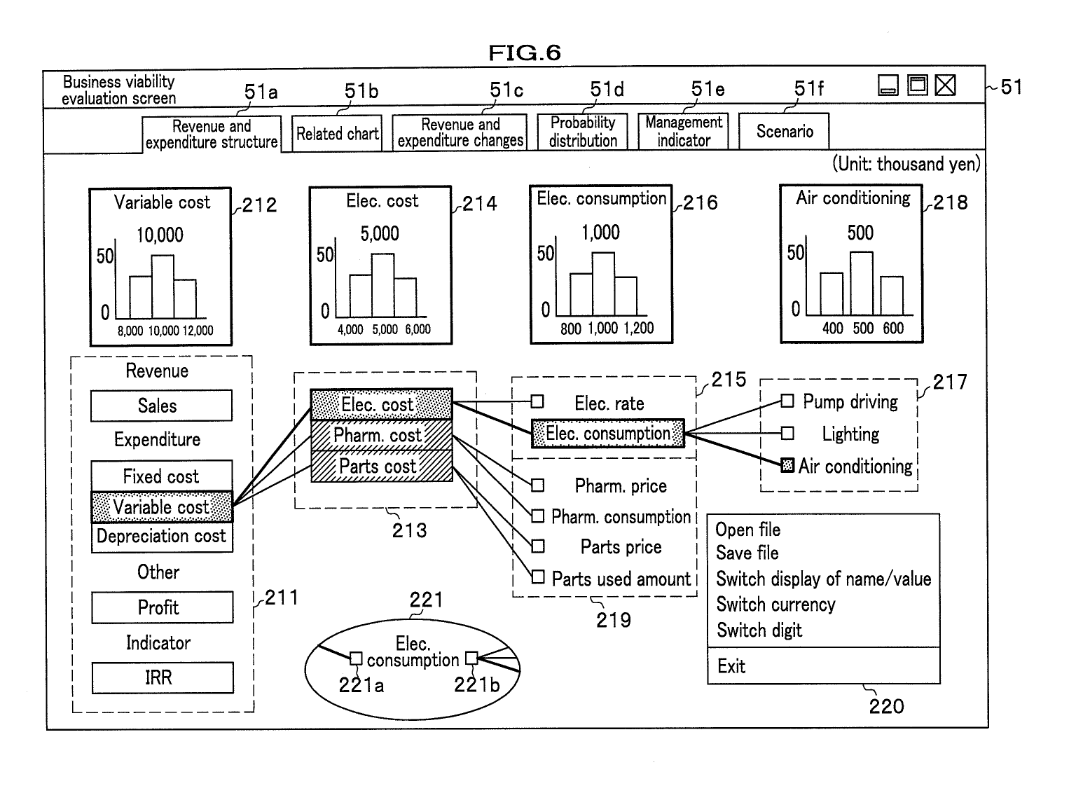

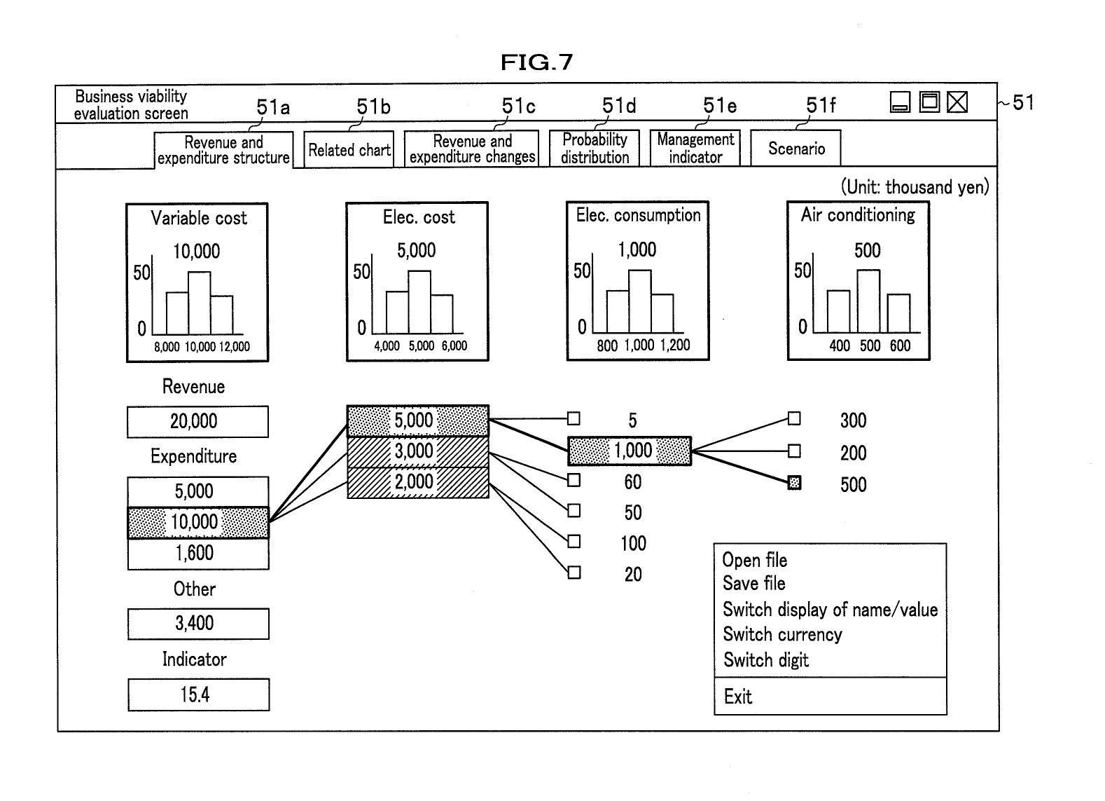

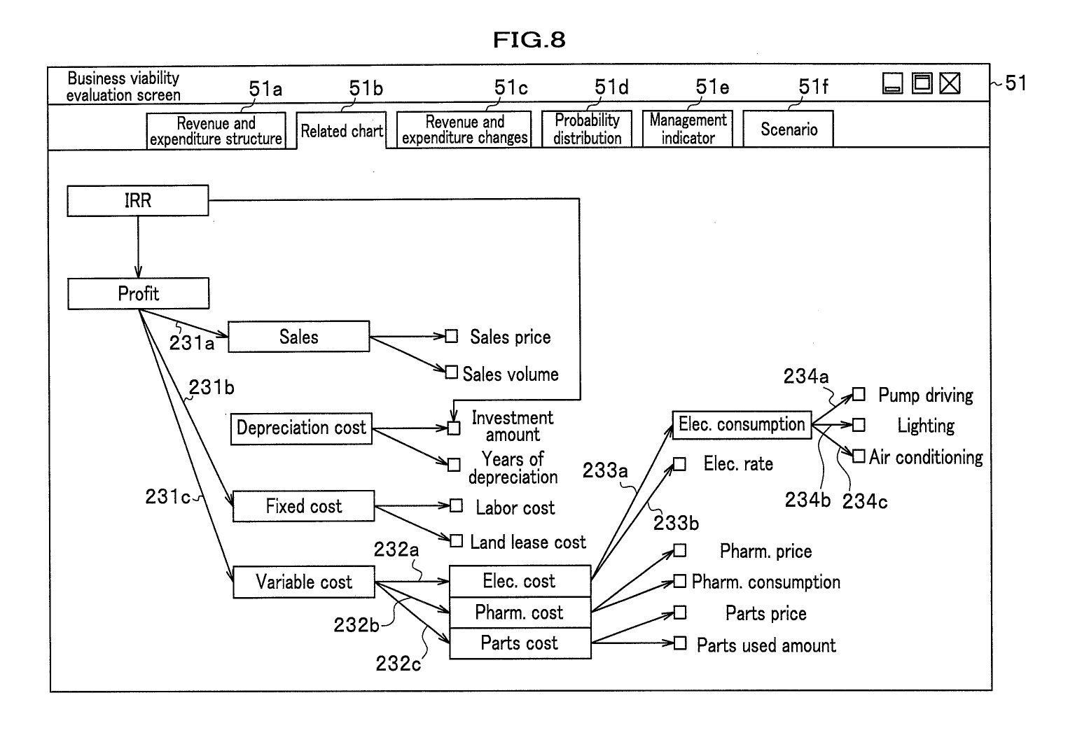

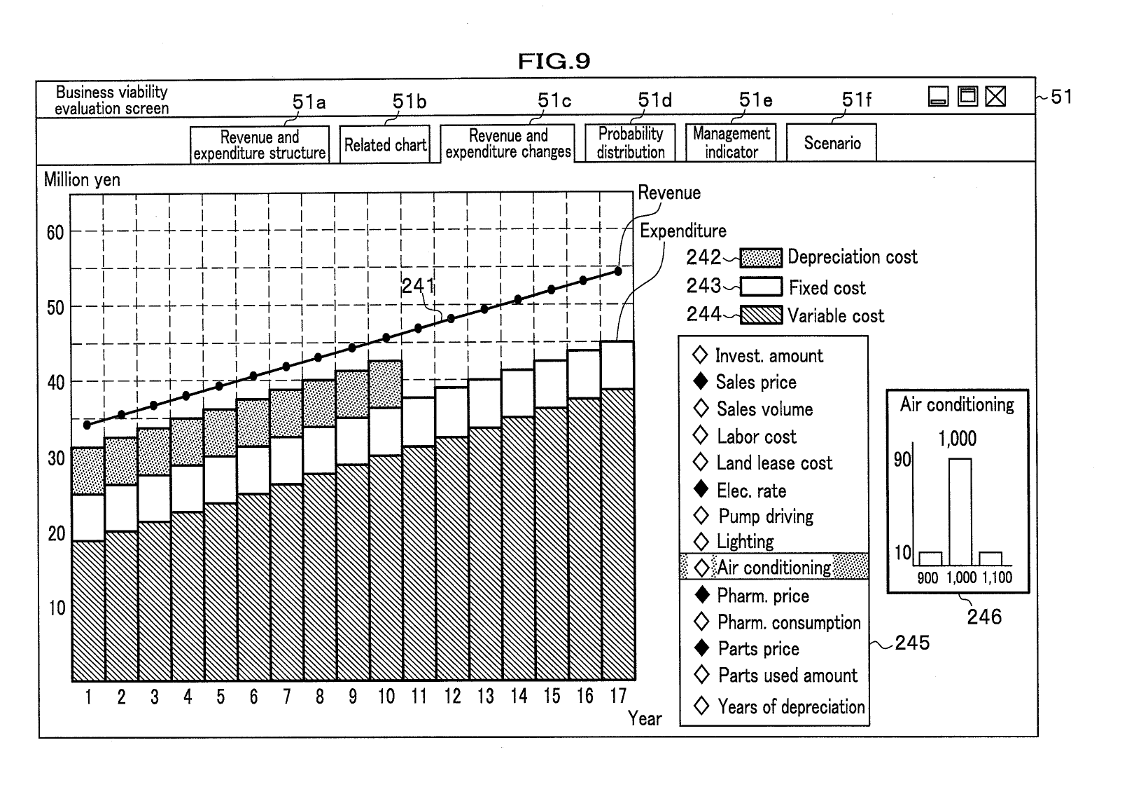

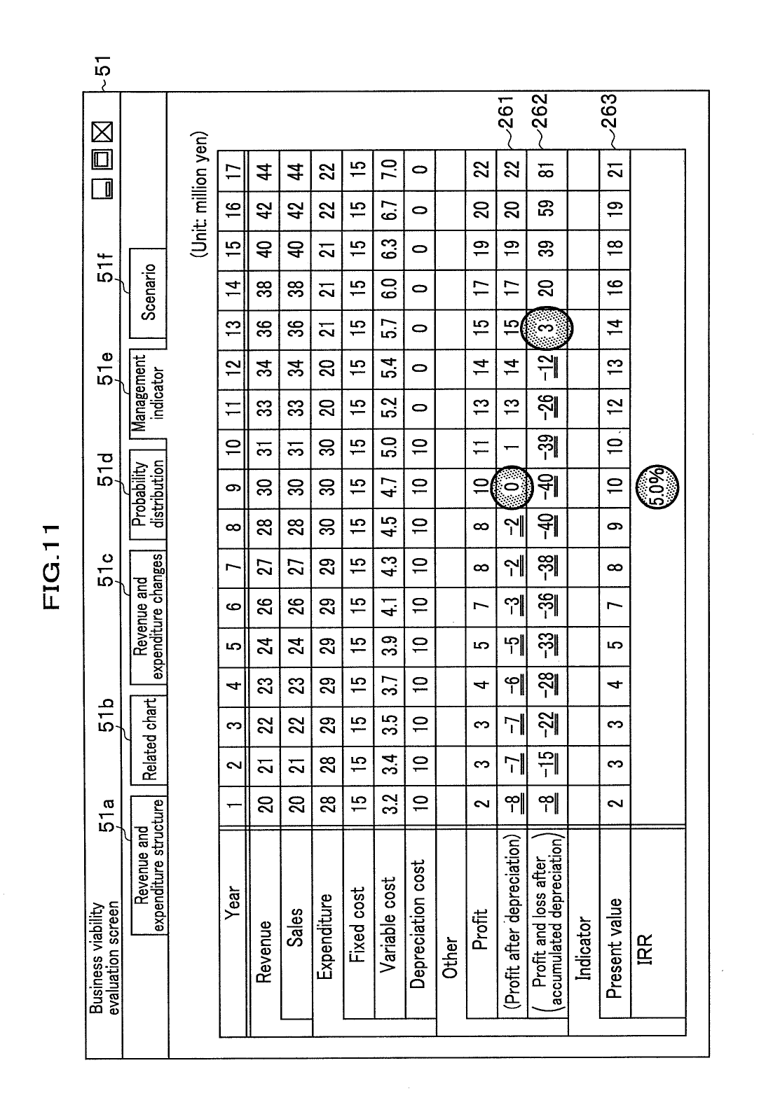

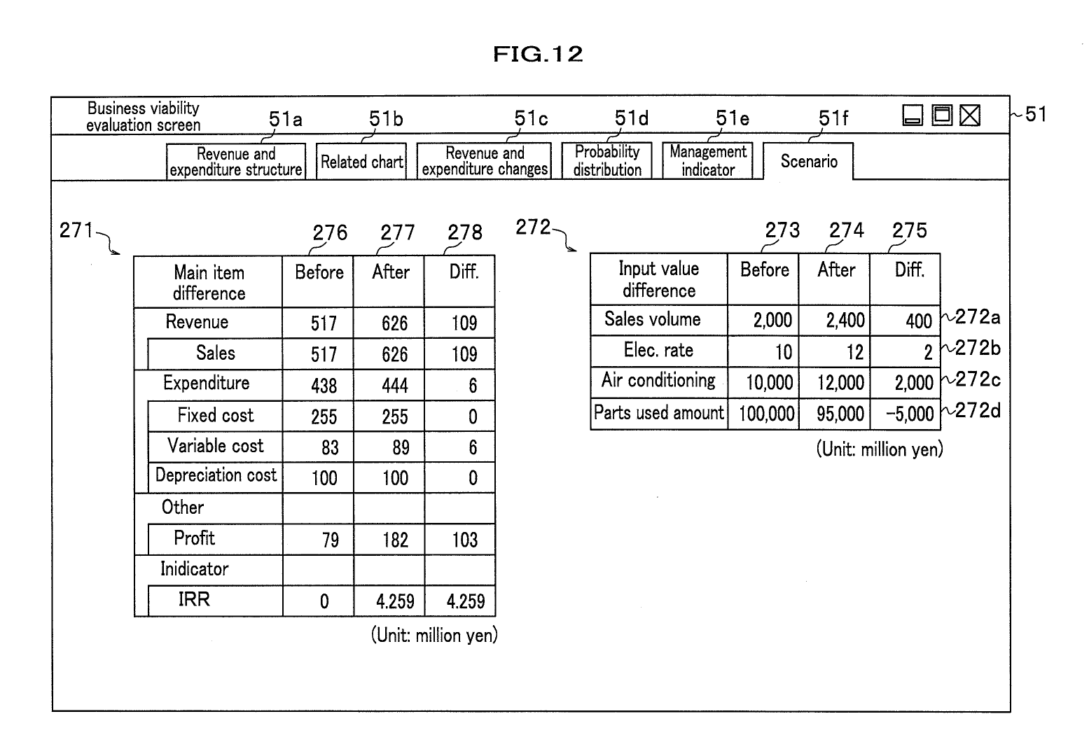

Next is described a layout of a business viability evaluation screen 51 (FIG. 6 to FIG. 12) which the business viability evaluation part 22 of the business viability evaluation apparatus 1 makes the output unit 13 display. The collectively-called business viability evaluation screen 51 is switchable among six screens 51a to 51f captioned by respective six tabs. The screens 51a to 51f are respectively referred to as the “revenue and expenditure structure screen 51a” and the like, in line with the respective captures such as “Revenue and expenditure structure” and the like. Of those screens 51a to 51f, the revenue and expenditure structure screen 51a (FIG. 6 and FIG. 7) and the related chart screen 51b (FIG. 8) each display data (such as a revenue and expenditure structure and a value of each item) stored in the revenue and expenditure structure description file 31 in a hierarchical form. The revenue and expenditure changes screen 51c (FIG. 9), the probability distribution screen 51d (FIG. 10), and the management indicator screen 51e (FIG. 11) each display a time-series change of a value of each item (in particular, a value of a main item) or the like. The scenario screen 51f (FIG. 12) displays how a value of a main item and a management indicator change before and after a re-entry of a prerequisite.

Referring to FIG. 6 and FIG. 7, the revenue and expenditure structure screen 51a is described. The business viability evaluation part 22 displays the revenue and expenditure structure screen 51a in the output unit 13 when an entry of data on a revenue and expenditure structure and a prerequisite has been completed. The business viability evaluation part 22 also displays a menu window 220 on the revenue and expenditure structure screen 51a. When the user clicks on “Open file” on the menu window 220 using a mouse or the like, the business viability evaluation part 22 displays a graphic (a rectangle in FIG. 6) in which main items and a management indicator are shown (designated at reference numeral 211). Assume a case in which the user selects “Variable cost” in a section 211 using a mouse. In response, the business viability evaluation part 22 displays a distribution chart 212 of the variable cost. Though details will be described later, by this stage, the business viability evaluation part 22 has already computed probability distributions of the variable cost and its lower-level items such as the electricity cost, based on the row 140 of FIG. 3. The business viability evaluation part 22 also displays a graphic in which items necessary for calculating the variable cost (designated at reference numeral 213) are shown.

Assume that the user then selects “Electricity cost” in a section 213 using the mouse. In response, the business viability evaluation part 22 displays a distribution chart 214 of the electricity cost. The business viability evaluation part 22 further displays a graphic in which items necessary for calculating the electricity cost are shown (designated at reference numeral 215). At this time, “Electrical consumption”, one of the items in the section 215, is displayed by being surrounded by a rectangle. In the meantime, “Electric rate”, another item, is displayed not by being surrounded by a rectangle but with a small checkbox. The two items are displayed differently because a value of the electric rate is entered as a prerequisite (the row 142 of FIG. 3), and in the meantime, a value of the electrical consumption is a calculation result of values of other items (the row 144 of FIG. 3). The business viability evaluation part 22 may otherwise display an item having a value as a calculation result of other items, as shown with a reference numeral 221 of FIG. 6. The character string of “Electrical consumption” has a graphic 221a on a left side thereof, which is an end point of a line indicating a relation with an upper item, and a graphic 221b on a right side thereof, which is a starting point of a line indicating a relation with a lower item. If a value of a given item is entered as a prerequisite, the graphic 221b as the starting point is not displayed.

Let the user select “Electrical consumption” in the section 215 using the mouse. In response, the business viability evaluation part 22 displays a distribution chart 216 of the electrical consumption. The business viability evaluation part 22 further displays a graphic in which items necessary for calculating the electrical consumption are displayed (designated at reference numeral 217). Finally, let the user select “Air conditioning” in the section 217 using the mouse. In response, the business viability evaluation part 22 displays a distribution chart 218 of the air conditioning.

The business viability evaluation part 22 may display the distribution charts 212, 214, 216, and 218 differently. The distribution charts 212, 214, and 216 of the variable cost, the electricity cost, and the electrical consumption, respectively, have respective middle bars in contact with corresponding bars on both sides. In the meantime, the distribution chart 218 of the air conditioning has a middle bar with gaps with each of the bars on the both sides. As will be understood, there are two different types of the distribution chart because a value of the air conditioning is entered as a prerequisite, and meanwhile, each of values of the variable cost, the electricity cost, and the electrical consumption is obtained from a calculation result of other items. The gaps make it easy for the user to transfer a given bar to where the user desires by grasping an upper side of the bar (to be described in detail hereinafter).

Description above is made assuming that the business viability evaluation part 22 displays graphics representing the distribution charts and the items step by step from upper level to lower level in response to a plurality of mouse manipulations by the user. Or, the business viability evaluation part 22 may display, when, for example, the user selects a graphic indicating “Variable cost” in the section 211, distribution charts and graphics of lower-level items of “Variable cost” all at once.

Further, in the step-by-step display, the business viability evaluation part 22 may change what is to be displayed according to selection by a user. For example, if the user selects and double clicks “Electricity cost” in the section 213 using the mouse, the business viability evaluation part 22 displays the distribution chart 214 and the section 215 containing items required for the electricity cost. Or, if, for example, the user selects and single clicks “Pharmaceutical cost” and “Parts cost” in the section 213 using the mouse, the business viability evaluation part 22 displays only a section in which necessary items are displayed (designated at reference numeral 219), without displaying distribution chart. At this time, the business viability evaluation part 22 highlights the selected graphic. In this case, how to highlight the graphic may be changed, such as a display in different colors, according to different methods of selecting an item by a double click, a single click, or the like.

If the user selects “Switch display of name/value” of the menu window 220 using the mouse or the like, the business viability evaluation part 22 switches display to the revenue and expenditure structure screen 51a illustrated in FIG. 7. At this time, the business viability evaluation part 22 displays, in place of names of all items, values (a mean value or an expected value) thereof. If the user selects “Switch display of name/value” again, the business viability evaluation part 22 returns display back to the revenue and expenditure structure screen 51a illustrated in FIG. 6. If the user selects “Switch currency” of the menu window 220 using the mouse or the like, the business viability evaluation part 22 switches, for each selection, currencies in such an order as: a first currency (yen)→a second currency (US dollar)→a third currency (euro)→the first currency (yen) and displays a value of an appropriate item in the currently-switched currency. If the user selects “Switch digit” of the menu window 220 using the mouse or the like, the business viability evaluation part 22 switches, for each selection, digits in such an order as: yen (US dollar, euro)→thousand yen (thousand US dollars, thousand euros)→million yen (million US dollars, million euros)→yen (US dollar, euro), and displays a value of an appropriate item in the switched currency.

With reference to FIG. 8, the related chart screen 51b is described. The business viability evaluation part 22 displays the related chart screen 51b in the output unit 13 when an entry of data on the revenue and expenditure structure has been completed. The related chart screen 51b contains a plurality of rectangular or square graphics and a plurality of arrows each of which connects between the graphics. The graphics correspond to respective items of the revenue and expenditure structure description file 31 (FIG. 2 and FIG. 3). The arrow corresponds to a row indicating a revenue and expenditure structure of the revenue and expenditure structure description file 31. For example, arrows 231a, 231b, and 231c correspond to the row 131 of FIG. 3. Arrows 232a, 232b, and 232c correspond to the row 140 of FIG. 3. Arrows 233a and 233b correspond to the row 141 of FIG. 3. Arrows 234a, 234b, and 234c correspond to the row 144 of FIG. 3. Note that the revenue and expenditure structure screen 51a shown in FIG. 6 and FIG. 7 displays the main items and a lower-level items thereof selected by the user. The related chart screen 51b, however, displays all of those items without any condition.

With reference to FIG. 9, the revenue and expenditure changes screen 51c is described. The business viability evaluation part 22 displays the revenue and expenditure changes screen 51c in the output unit 13 when an entry of data on a revenue and expenditure structure and an entry (or a re-entry) of a prerequisite have been completed. The revenue and expenditure changes screen 51c displays a mean value or an expected value of a value of a given item specified by the user in time series through all project periods. FIG. 9 is a display example in a case where the user specifies “Revenue” and “Expenditure”. By referring back to FIG. 2, it will be understood that only “Sales” is present as the revenue, and “Fixed cost”, “Variable cost”, and “Depreciation cost” are present as the expenditure. The business viability evaluation part 22 thus displays a line graph 241 representing time series changes of the revenue (that is, Sales), and bar graphs representing a depreciation cost 242, a fixed cost 243, and a variable cost 244 as the expenditure.

The business viability evaluation part 22 also displays an entry item window 245 on the revenue and expenditure changes screen 51c. Items of the entry item window 245 correspond to the shaded rows of FIG. 3. If the user selects an item in the entry item window 245, the business viability evaluation part 22 displays a distribution chart 246 of the selected item (as it was at the time of an initial entry or a re-entry). The business viability evaluation part 22 may have a plurality of forms of displaying an item of the entry item window 245. For example, the business viability evaluation part 22 may display an item whose rate of change is defined by “YearlyGrowth” with a mark of “♦”; an item whose rate of change is defined by “YearlyRate” with a mark of “♦♦”; and an item whose rate of change cannot be defined with a mark of “⋄”.

With reference to FIG. 10, the probability distribution screen 51d is described. The business viability evaluation part 22 displays the probability distribution screen 51d in the output unit 13 when an entry of data on a revenue and expenditure structure and an entry (or a re-entry) of a prerequisite have been completed. The probability distribution screen 51d displays a mean value or an expected value of a value of a given item (in particular, a main item) specified by the user and a probability distribution of the value of the item in time series through all of the project periods. FIG. 10 is an example in which the user has specified “Revenue” and “Expenditure”. The revenue herein corresponds to a sum of a fixed cost, a variable cost, and a depreciation cost. A line 251 shows a mean value or an expected value of the revenue. Similarly, a line 252 shows a mean value or an expected value of the expenditure. Each of points indicating the mean values or the expected values in respective periods on the line 251 has a distribution bar (for example, reference numeral 253) extending both upward and downward from the point.

### <Distribution Bar>

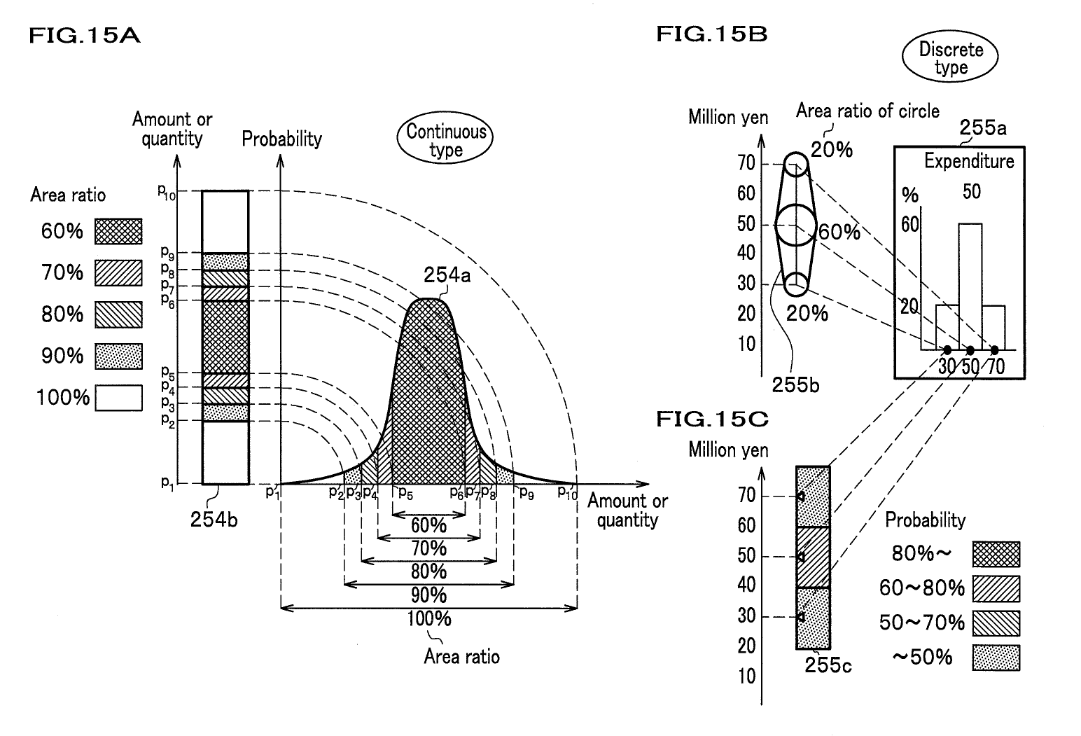

For convenience of explanation, FIG. 11 to FIG. 14 will be described later. With reference to FIG. 15, next is described a distribution bar. The business viability evaluation part 22 can compute and store a value of an item both as a probability distribution of continuous type and as a probability distribution of discrete type. More specifically, the business viability evaluation part 22 can convert a discrete-type probability distribution specified by parameters of the mean value and the accuracy (such as “Approx80”) into a continuous probability distribution specified by parameters of the mean value and a distribution, and vice versa, using known methods such as spline interpolation, sampling, and quantization.

FIG. 15A illustrates how the business viability evaluation part 22 transforms and displays a graphic of a continuous-type probability distribution 254a into a distribution bar 254b. For example, let an integrated value (an area bounded by a curve of a probability distribution and the horizontal axis) from p₅ to p₆ be 60% of an integrated value from p₁ to p₁₀, with a vertical line of a mean value at its center. The business viability evaluation part 22: creates a rectangle as the distribute bar 254b having a bottom side at a position corresponding to p1 and a top side at a position corresponding to p₁₀ of the vertical axis on a coordinate plane as shown in FIG. 10; draws a horizontal line at each of a vertical axis position p₅ and a vertical axis position p₆; and fills an area between the horizontal lines with a color (or a pattern) indicating a “60%” section. Similarly, horizontal lines are drawn to establish a “70%” section and the like of the rectangle distribution bar 254b with different colors.

FIG. 15B illustrates how the business viability evaluation part 22 transforms and displays a graphic of a discrete-type probability distribution 255a into a distribution bar 255b. For example, let a probability of a revenue amounting to 50 million yen be 60%; 30 million yen, 20%; and 70 million yen, 20%. The business viability evaluation part 22 draws a vertical line between vertical axis positions “70 million yen” and “30 million yen” on the coordinate plane as shown in FIG. 10, and then draws a first circle having an area ratio corresponding to 20%, with a center of the first circle at the vertical axis position “70 million” on the line. Similarly, the business viability evaluation part 22 draws a second circle having an area ratio corresponding to 20%, with a center of the second circle at the vertical axis position “30 million” on the line, and a third circle having an area ratio corresponding to 60%, with a center of the third circle at the vertical axis position “50 million” on the line. The business viability evaluation part 22 finally draws an external tangent of the first, second, and third circles, thus completing the distribution bar 255b. Note that in a case where the number of discrete values is other than three, the distribution bar 255a and the distribution bar 255b can be similarly displayed.

FIG. 15C illustrates how the business viability evaluation part 22 transforms and displays a graphic of a probability distribution of discrete type 255a into a distribution bar of other type 255c. For example, the business viability evaluation part 22 assumes a vertical line between vertical axis positions “70 million yen” and “30 million yen” on the coordinate plane as shown in FIG. 10, and then draws a first rectangle which has the vertical axis position “70 million yen” on the line as a midpoint of a left side thereof. Similarly, the business viability evaluation part 22 draws a second rectangle which has the vertical axis position “30 million yen” on the line as a midpoint of a left side thereof, and a third rectangle which has the vertical axis position “50 million yen” on the line as a midpoint of a left side thereof. The business viability evaluation part 22 finally fills insides of the first, second, and third rectangles with different colors (or patterns) indicating respective probabilities. If discrete values of the probability distribution 255a are equally spaced (for example, 70−50=50−30), the business viability evaluation part 22 may display the first to third rectangles with no space therebetween. The business viability evaluation part 22 thus completes the distribution bar 255c. The distribution bar 255b and the distribution bar 255c display essentially the same contents. Nonetheless, if a width of a screen is not sufficiently wide because, for example, an entire project period is lengthy or there are so many periods in a project, it is convenient for the user to see the distribution bar 255c.

Referring back to FIG. 11, the management indicator screen 51e is described. The business viability evaluation part 22 displays the management indicator screen 51e in the output unit 13, after an entry of data on a revenue and expenditure structure and an entry (or a re-entry) of a prerequisite has been completed. The management indicator screen 51e displays a mean value or an expected value of a value of a main item in time series through all of the project periods. Note that a profit after depreciation (a row 261), a profit and loss after accumulated depreciation (a row 262), and a present value (a row 263) are not defined directly from the revenue and expenditure structure exemplified in FIG. 2 and FIG. 3. Those items are herein exemplified by way of indicating that it is possible to define and display such items in time series.

The business viability evaluation part 22 may highlight a negative value (for example, with an underline, in red color, or the like). Further, when any of a plurality of values in time series appears as a positive value for the first time, the business viability evaluation part 22 may highlight the positive value (for example, surrounding with a circle or the like). The business viability evaluation part 22 may change how to display a value of an IRR according to a magnitude relationship between the value of the IRR and, for example, a yield of a long-term government bond. An example is that, if IRR Yield of government bond, the value of the IRR is displayed in blue, and otherwise, in red.

With reference to FIG. 12, the scenario screen 51f is described. Assume that the user has just completed entry of data on a revenue and expenditure structure and a prerequisite (an initial value). Of the entered items, let a mean value (or an expected value, hereinafter the same) of a sales volume be “2,000”; a mean value of an electric rate, “10”; a mean value of an air conditioning, “10,000”; and an amount of used parts, “100,000”. Let the user re-enter “2,400” as the mean value of the sales volume. Note that how to specifically change and re-enter data will be described later.

In this stage, the business viability evaluation part 22 displays a row 272a of an input value difference 272 on the scenario screen 51f. At this time, “2,000” is displayed in a Before field 273 of the row 272a; “2,400”, in an After field 274; and “400”, in a Diff. field 275. “400” is a calculation result obtained by subtracting “2,000” from “2,400”. The business viability evaluation part 22 also displays respective calculation results of main items and a management indicator calculated by using an initial value, in a Before field 276 of a main item difference 271. The business viability evaluation part 22 then displays respective calculation results of main items and a management indicator calculated by using the re-entered “2,400” of the air conditioning and initial values of other items, in an After field 277. The business viability evaluation part 22 further displays a value obtained by subtracting the value in the Before field 276 from the value in the After field 277, in a Diff. field 278.

Assume that the user then re-enters “12” as the mean value of the electric rate. In response, the business viability evaluation part 22 displays a row 272b of the input value difference 272 on the scenario screen 51f. At this time, “10” is displayed in the Before field 273 of the row 272b; “12”, in the After field 274; and “2”, in the Diff. field 275. Herein, “2” is a calculation result obtained by subtracting “10” from “12”. The business viability evaluation part 22 also displays calculation results of respective main items and a management indicator calculated by using the initial values as they are, in the Before field 276 of the main item difference 271. The business viability evaluation part 22 then displays calculation results of respective main items and a management indicator obtained by using: the mean value “2,400” of the re-entered sales volume; the mean value “12” of the electric rate; and respective initial values of the items, in the After field 277. The business viability evaluation part 22 further displays a value obtained by subtracting the value in the Before field 276 from a value in the After field 277, in the Diff. field 278.

Each time the user changes and re-enters a value of other item, the business viability evaluation part 22 adds a new row to the input value difference 272 and displays the re-entered value in the added row (such rows as 272c and 272d). Similarly, the business viability evaluation part 22 updates and displays the main item difference 271. Note that, if a net present value of a project takes a negative value, “0” is displayed as the IRR of the main item difference 271.

### <Steps of Entire Processing>

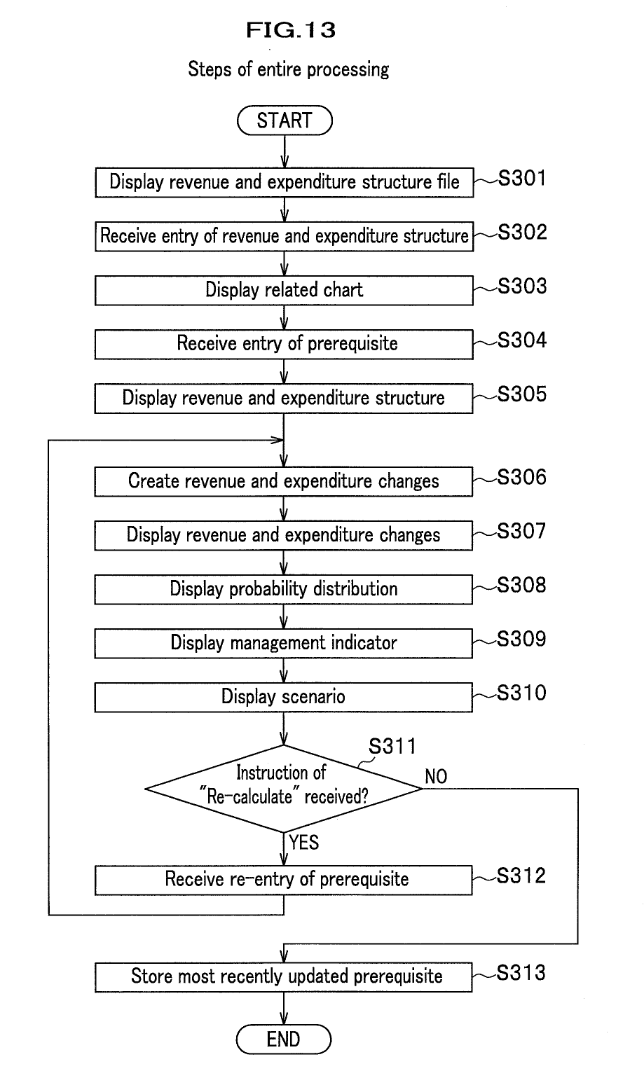

With reference to FIG. 13, steps of an entire processing are described.

In step S301, the data management part 21 displays a revenue and expenditure structure file. More specifically, the data management part 21 displays the revenue and expenditure structure description file 31 (FIG. 2 and FIG. 3) as an entry format, in the output unit 13. In this stage, all fields and rows of the file 31 are blank.

In step S302, the data management part 21 receives an entry of data on a revenue and expenditure structure. More specifically, the data management part 21 receives that a user enters a character string and an operator (such as “+”) into a field of the revenue and expenditure structure description file 31 via the input unit 12 such as a keyboard, to thereby prepare a row of a revenue and expenditure structure.

In step S303, the business viability evaluation part 22 displays a related chart. More specifically, the business viability evaluation part 22 displays the related chart screen 51b (FIG. 8) in the output unit 13, based on the revenue and expenditure structure received in step S302.

In step S304, the data management part 21 receives an entry of a prerequisite. More specifically, firstly, the data management part 21 receives that the user enters a character string and a value into appropriate fields of the revenue and expenditure structure description file 31 via the input unit 12 such as a keyboard, to thereby prepare a row of a prerequisite. At this time, the data management part 21 highlights the operator field 103 and the value1 field 104 of the row into which the user has entered necessary data, using “shading” or the like.

Secondly, the data management part 21 stores the revenue and expenditure structure description file 31 to which entry of all necessary data has been completed, in the auxiliary memory unit 15, in response to selection of “Save file” of the menu window 220 (FIG. 6) by the user. Note that the menu window 220 is illustrated in FIG. 6 and the like for convenience of explanation. However, the menu window 220 is displayed on any appropriate screen any time in response to instructions from the user.

In step S305, the business viability evaluation part 22 displays a revenue and expenditure structure. More specifically, the business viability evaluation part 22 displays the revenue and expenditure structure screen 51a (FIG. 6 and FIG. 7) in the output unit 13, based on the revenue and expenditure structure received in step S302 and the prerequisite received in step S304. At this time, the business viability evaluation part 22 may display any one of the revenue and expenditure structure screen 51a of FIG. 6 and the revenue and expenditure structure screen 51a of FIG. 7 in preference to the other, and, in response to selection of “Switch display of name/value” of the menu window 220 by the user, may switch the display to the other.

In step S306, the business viability evaluation part 22 shows revenue and expenditure changes. More specifically, the business viability evaluation part 22 calculates a value of a main item through all periods of the project, based on the revenue and expenditure structure description file 31 into which entry of all necessary data has been completed, to thereby create output information in time series. How to compute a probability distribution is as described above.

In step S307, the business viability evaluation part 22 displays the revenue and expenditure changes. More specifically, the business viability evaluation part 22 displays the revenue and expenditure changes screen 51c of FIG. 9 in the output unit 13, based on the time-series output information created in step S306.

In step S308, the business viability evaluation part 22 displays a probability distribution. More specifically, the business viability evaluation part 22 displays the probability distribution screen 51d of FIG. 10 in the output unit 13, based on the time-series output information created in step S306.

In step S309, the business viability evaluation part 22 displays a management indicator. More specifically, the business viability evaluation part 22 displays the management indicator screen 51e of FIG. 11 in the output unit 13, based on the time-series output information created in step S306.

In step S310, the business viability evaluation part 22 displays a scenario. More specifically, the business viability evaluation part 22 displays the scenario screen 51f of FIG. 12 in the output unit 13, based on the time-series output information created in step S306. When the processing enters step S310 for the first time, the input value difference 272 is not displayed on the scenario screen 51f. The main item difference 271 is displayed only in the Before field 276 with appropriate values. The After field 277 and the Diff. field 278 are blank. Meanwhile, when the processing enters step S310 during a loop, all of those fields are displayed with appropriate values.

An order from steps S307 to S310 can be arbitrarily changed. At an arbitrary point of time from steps S307 to S310, the business viability evaluation part 22 switches the display among the revenue and expenditure structure screen 51a through the scenario screen 51f, in response to selection by the user of tags corresponding to the screens 51a to 51f of the business viability evaluation screen 51.

In step S311, the business viability evaluation part 22 determines whether or not an instruction of “Re-calculate” is received. More specifically, if the business viability evaluation part 22 receives an entry of an instruction from the user to create time-series output information of a value of a main item using a given method (if “YES” in step S311), the business viability evaluation part 22 advances the processing to step S312. If the business viability evaluation part 22 receives a selection of “Exit” of the menu window 220 from the user (if “NO” in step S311), the business viability evaluation part 22 advances the processing to step S313.

In step S312, the business viability evaluation part 22 receives a re-entry of the prerequisite. More specifically, firstly, the business viability evaluation part 22 displays the entry item window 245 (FIG. 9).

Secondly, the business viability evaluation part 22 receives a selection of any one of entry items of the entry item window 245 from the user and displays a distribution chart 246 (FIG. 9) of the received entry item. Note that for convenience of explanation, the entry item window 245 and the distribution chart 246 are displayed on the revenue and expenditure changes screen 51c (FIG. 9), but they may be displayed on any other screen.

Thirdly, the business viability evaluation part 22 receives a re-entry of a value of the prerequisite from the user, using the displayed distribution chart.

### <Re-Entry of Prerequisite>

Referring back to FIGS. 4A to 4C, the re-entry of a prerequisite is described. Let a distribution chart currently being displayed on a screen be the distribution chart 161 of FIG. 4A. There are, for example, two methods for the user to conveniently re-enter a value of the prerequisite.

The first method is a “horizontal translation” as illustrated in FIG. 4B. Assume a case in which that the business viability evaluation part 22 receives that the user points a cursor or a finger to “500” displayed just below a character string of “Air conditioning” and then moves the cursor or the finger rightward by “100” in terms of a coordinate value (a reference numeral 162). At this time, the business viability evaluation part 22 parallel-translates a middle bar rightward to a position of a coordinate value “600”; a left bar rightward to a position of the coordinate value “480”; and a right bar rightward to a position of a coordinate value “720” (a reference numeral 163). Herein, “600” is a calculation result of “500+100”; “480”, “600−600×(100%−80%)”; and “720”, “600+600×(100%-80%)”. The data management part 21 temporarily stores “600”(=500+100) as a value in the value1 field 104 of the revenue and expenditure structure description file 31, in the main memory unit 14.

The second method is a “vertical translation” as shown in FIG. 4C. The business viability evaluation part 22 receives that the user grabs a top side of any one of the middle, left, and right bars and drags the top side thereof upward or downward (a reference numeral 164). Assume herein a case in which the user moves the top side of the right bar upward by “30%” in terms of the coordinate value. In response, the business viability evaluation part 22 shifts the top side of the right bar upward by “30%” in terms of the coordinate value; the top side of the middle bar downward by “27%”; and the top side of the left bar downward by “3%” (a reference numeral 165). Before the shift, the middle bar indicates “80%” on the vertical axis; and the left bar, “10%”. A distance of the shift of the top side of the right bar corresponds to “30%” in terms of the coordinate value. The business viability evaluation part 22 obtains “27%” as a calculation result of 30×80/(80+10); and, “3%” as a calculation result of 30×10/(80+10). The data management part 21 stores “−3, −27, +30” in the value2 field 105 of the revenue and expenditure structure description file 31 and temporarily holds the stored data in the main memory unit 14. Herein, “−3” indicates that a discrete-type normal distribution specified by two parameters, namely, an accuracy “Approx80” and a mean value “500”, the discrete-type normal distribution being herein taken as a reference distribution, has the left bar reduced by “−3%” (that is, the top side moved downward by 3%). The same applies to “−27” and “+30”.

The business viability evaluation part 22 returns the processing to step S306. The business viability evaluation part 22 and the like then repeat steps S306 to S312 based on the re-entered prerequisite value and other initial values concerned.

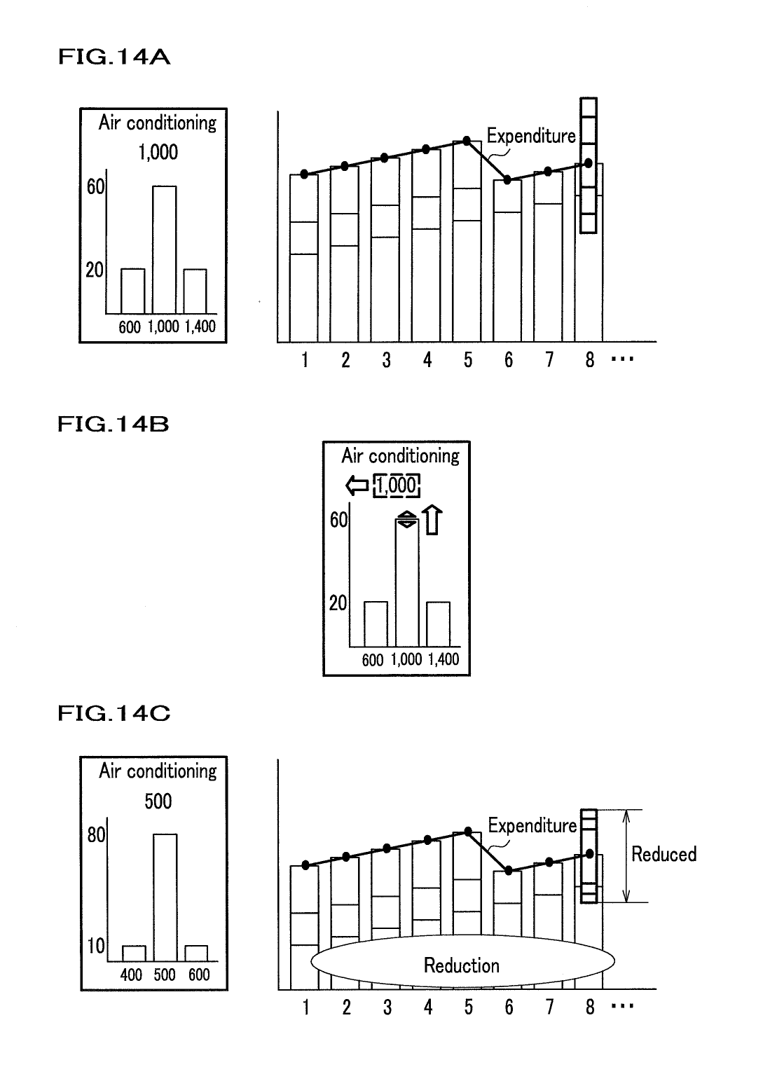

With reference to FIGS. 14A, 14B, and 14C, how data on a screen displayed for the user is changed during a loop is described. Assume a case in which what is currently displayed for the user is a distribution chart and a line graph of an expenditure, a distribution bar of the expenditure in an “eighth period”, and bar graphs of a depreciation cost, a fixed cost, and a variable cost (FIG. 14A). Also assume that the user performs two operations as follows on the screen (FIG. 14B).

<First operation> The user shifts a mean value (or an expected value) of the distribution chart from “1,000” to “500”. The distribution chart herein is prepared based on a current value stored in the revenue and expenditure structure description file 31, that is, an initial value entered at a beginning, or on a value updated from the initial value.

<Second operation> The user shifts a top side of the middle bar from “60” to “80”.

In response, the business viability evaluation part 22 displays the bars of the variable cost with appropriately reduced values (FIG. 14C), which corresponds to “First operation”. The business viability evaluation part 22 at the same time displays the distribution bar of the expenditure in the “eighth period” with an appropriately reduced value (FIG. 14C), which corresponds to “Second operation”. In the loop, the business viability evaluation apparatus 1 repeatedly performs such an interactive processing with the user.

In step S313, the data management part 21 stores the most recently updated prerequisite. More specifically, the data management part 21 overwrites the data having been temporarily held in the “thirdly” performed operation of step S312 in the loop for the last time, over the revenue and expenditure structure description file 31 and stores the overwritten data in the auxiliary memory unit 15. Note that, if step S312 has not been performed even once, the data management part 21 skips step S313.

Then, the data management part 21 terminates the steps of the entire processing.

In this embodiment, description is made assuming that a discrete probability distribution has three discrete values. However, the number of the discrete values is not limited to three. The business viability evaluation part 22 may display a distribution chart (as shown in FIG. 4A, for example) having n units of normally-distributed discrete values (n is a natural number). Further, n may be an odd number.

### Advantageous Effects of Embodiment

(1) The business viability evaluation apparatus 1 receives an entry of data on a revenue and expenditure structure and a prerequisite with appropriate changes of a row of a table and timing. Further, the business viability evaluation apparatus 1 repeats a processing of: receiving a re-entry of a changed prerequisite while keeping the revenue and expenditure structure unchanged; and displaying a calculation result of a main item or the like based on the re-entry. This has advantageous effects that an erroneous input is reduced and that a user can know a relation between a change in a prerequisite and a calculation result of a main item or the like in an interactive and visible manner.

(2) When a prerequisite is re-entered, the business viability evaluation apparatus 1 displays a distribution chart showing a current value of the prerequisite and receives a manipulation of the displayed distribution chart by the user. This has advantageous effects that the revenue and expenditure structure is not negatively affected and that how to manipulate the displayed distribution chart becomes easy for the user to understand.

(3) The business viability evaluation apparatus 1 receives a prerequisite as a probability distribution and displays the prerequisite as a plurality of discrete values. This has advantageous effects that, even if the prerequisite is not determined as a specific value, an entry of the prerequisite becomes available and that a distribution of the entered value can be easily understood in a visual manner.

(4) The business viability evaluation apparatus 1 differently displays one prerequisite that has its lower-level prerequisite and another prerequisite that does not have. This has an advantageous effect that which item allows a re-entry can be easily recognized in a visual manner.

(5) The business viability evaluation apparatus 1 receives a probability distribution as n units of normally-distributed discrete values (n is a natural number). This has an advantageous effect that a processing speed is improved.

(6) The business viability evaluation apparatus 1 displays a calculation result of a main item as a probability distribution. This has an advantageous effect that viability of a future business can be easily recognized.

The present invention is carried out not only by the above-described embodiment but also by various variations. For example, the above-described embodiment is intended to be illustrative of the present invention in an easily understandable manner and the present invention is not limited to the one that includes all of the components explained in the embodiment. Part of a configuration of an example of the present invention may be substituted by or added to that of another example. Part of a configuration of an example may be deleted.

Part or all of a configuration, a feature, a processing part, a processing unit, or the like may be embodied by hardware by means of, for example, designing of integrated circuits. The above-described configuration, feature, or the like may be embodied by software in which, for example, a processor interprets and executes a program which realizes the feature. Data of a program, a table, a file, and the like for realizing such a feature can be stored in a storage device including a memory, a hard disk, and a SSD (Solid State Drive) or in a storage medium including an IC card, an SD card, and a DVD.

In the present invention, only a control line and an information line which are deemed necessary for explanation are illustrated, and not all of them which may be necessary as a product are illustrated. In practice, almost all configurations are connected to each other.

1. A business viability evaluation apparatus, comprising:
a data management part that receives that a user enters a calculation process which is a process of calculating a value of an evaluation item for evaluating a business and a prerequisite which is an input value to the calculation process; and
a business viability evaluation part that creates a value of the evaluation item in time series based on the calculation process and the prerequisite, displays the value of the evaluation item created in time series, receives that the user re-enters a changed prerequisite, re-creates a value of the evaluation item in time series based on the calculation process and the changed prerequisite, and displays the value of the evaluation item re-created in time series.

2. The business viability evaluation apparatus according to claim 1,
wherein, when the business viability evaluation part receives that the user re-enters the changed prerequisite, the business viability evaluation part: displays a possible prerequisite which allows the user to re-enter; receives that the user selects a prerequisite to be re-entered from the possible prerequisite; displays a graphic indicating a current value of the selected prerequisite; and receives that the user manipulates the graphic and thereby changes the current value.

3. The business viability evaluation apparatus according to claim 2,
wherein, when the data management part receives the prerequisite, the data management part receives the prerequisite as a probability distribution, and
wherein the business viability evaluation part displays the graphic as a representation of a plurality of discrete values each of which is a combination of a value of the prerequisite and a probability of occurrence of the value.

4. The business viability evaluation apparatus according to claim 3,
wherein the business viability evaluation part: receives that the user manipulates a plurality of the discrete values represented by the graphic; changes the probability distribution of the prerequisite based on the user's manipulation; and re-creates a value of the evaluation item in time series.

5. The business viability evaluation apparatus according to claim 4,
wherein the business viability evaluation part: displays a hierarchical relation between the evaluation item and the prerequisite; and differently displays one prerequisite that has a hierarchically lower-level prerequisite and another that does not have hierarchically lower-level prerequisite.

6. The business viability evaluation apparatus according to claim 5,
wherein the business viability evaluation part: receives the probability distribution as n units of normally-distributed discrete values, wherein n is an odd number; and displays the graphic as n units of the normally-distributed discrete values.

7. The business viability evaluation apparatus according to claim 6,
wherein, when the business viability evaluation part displays the value of the evaluation item, the business viability evaluation part displays a graphic representing a probability distribution of the value of the evaluation item.

8. A business viability evaluation method performed by a business viability evaluation apparatus including a data management part and a business viability evaluation part, the business viability evaluation method, comprising:
the step, performed by the data management part, of receiving that a user enters a calculation process which is a process of calculating a value of an evaluation item for evaluating a business and a prerequisite which is an input value to the calculation process; and
the steps, performed by the business viability evaluation part, of creating the value of the evaluation item in time series based on the calculation process and the prerequisite; displaying the value of the evaluation item created in time series; receiving that the user re-enters a changed prerequisite; re-creating a value of the evaluation item in time series based on the calculation process and the changed prerequisite; and displaying the value of the evaluation item re-created in time series.

9. A non-transitory computer-readable medium embodying a business viability evaluation program to execute the business viability evaluation method according to claim 8.
